(19) United States
(12) Patent Application Publication
(10) Pub. No.: US 2004/0263863 A1
(43) Pub. Date: Dec. 30, 2004

(54) System and method for design and manufacture of custom face masks

(76) Inventors: William E. Rogers, Bulverde, TX (US); Gordon Bosker, San Antonio, TX (US)

Correspondence Address: ERIC B. MEYERTONS, MEYERTONS, HOOD, KIVLIN, KOWERT & GOETZEL, P.C., P.O. BOX 398, AUSTIN, TX, 78767-0398, US

(21) Appl. No.: 10/765,826

(22) Filed: Jan. 27, 2004

Related U.S. Application Data
(60) Provisional application No. 60/442,936, filed on Jan. 27, 2003.

(51) Int. Cl. G01B 11/24

(52) U.S. Cl. 356/602

(57) ABSTRACT

Methods and systems for forming face masks are disclosed. Embodiments may utilize computer-aided design and computer-aided manufacturing to form custom fitted face masks. System software may be configured to acquire facial topography information, design a mask based on the topography information, and send mask information to a computerized manufacturing device. The software may communicate with a scanning device for facial topography acquisition and a milling machine for pattern fabrication. In an embodiment, the scanning device may include a linear scan non-contact laser imager. In an embodiment, the scanning device may be manually moved with respect to an individual being scanned, thereby eliminating the need for motive apparatus. In such embodiments, position information may be determined based on data from a position sensor coupled to the scanning device.

### PRIORITY CLAIM

This application claims priority to Provisional Patent Application No. 60/442,936 entitled “System and Method for Design and manufacture of Custom Face Masks” filed on Jan. 27, 2003.

### BACKGROUND OF THE INVENTION 1. Field of the Invention

Embodiments disclosed herein generally relate to methods and systems for forming face masks.

2. Description of the Relevant Art

The face is one of the most frequently burned areas of the body [1, 2]. The formation of hypertrophic scars and deforming contractures may lead to devastating facial disfigurement and functional problems. The patient may experience difficulty with vision, speech and/or feeding along with a significant increase in the psychological stress associated with burn trauma. Nonsurgical and post-surgical management of facial scarring creates a difficult clinical problem for the therapist who must attempt to obtain the best possible functional and cosmetic outcome/result [3, 4].

Though a variety of techniques are available, application of uniform compression to hypertrophic scared areas of the body provides the advantage of accelerating the scar maturation process [1] with minimal side effects. The use of pressure as a means to control hypertrophic scars has been reported as early as 1860, but it was not until the 1960's that it became a mainstream treatment modality [5]. Hypertrophic scars and contractures can be minimized by maintaining pressure until scar maturation, ideally 24 hours per day for up to 12 to 18 months.

The University of Minnesota has used elastic garments since 1966, to treat patients with hypertrophic scars. The Jobst Company, a manufacturer of elastic garments, ships pressure garments for patients with burns to medical centers all over the world. Elastic garments seem to work well over tubular areas of the body. However, elastic garments may not provide uniform pressure to contoured areas of the body, resulting in a tendency of those areas to form hypertrophic scars. Foam or elastomeric inserts may lessen this problem. However, these appliances are usually opaque, which makes it difficult to determine optimal fit.

A transparent facial mask (TFM) fabricated from an accurate pattern of the head eliminates many of the disadvantages of elastic hoods [6]. The vascular blanching of scar beneath the TFM assists the therapist in determining proper fit. Within the past decade, the technique for applying pressure to the face has shifted from the elastic face mask to the plastic TFM. A mail survey done in 1990 indicated that 90% of therapists used an elastic face mask over a plastic face mask [4]. Then in 2001, a random survey distributed to therapists at the American Burn Association conference reported that eighty-one percent used TFM to treat facial scars [8].

Fabricating a TFM by conventional means may be labor intensive and may require a skilled artisan. In a recent survey given to therapists, sixty-four percent reported 6-10 hours of staff involvement in the fabrication of a TFM and sixty-eight percent stated that the most difficult aspect of making a TFM was “casting” or “modifying the mold” [8]. The survey revealed that eighty-six percent of therapists needed to recast the mold for reasons other than growth.

Conventional manufacturing of face masks involves three general steps. First, a cast is made of the patient's face. The second step is to make a plaster pattern from the cast for fabricating the mask. The third step is to mold the plastic over the plaster pattern.

Dental alginate is typically used as a casting material. The alginate is poured over the patient's face and allowed to harden. Oftentimes, straws are inserted in the nostrils allowing the patient to breathe. Plaster strips may be applied on top of the alginate to provide support. This casting procedure may take about thirty minutes. For the patient, creating a cast of the face may be an uncomfortable, anxiety provoking, claustrophobic procedure. Children or anxious adults may require general anesthetic before undergoing the casting procedure.

The finished cast may be filled with plaster to make a positive pattern for molding the mask. After casting, the pattern may be smoothed and plaster material may be removed from the pattern to apply pressure to scarred areas. The area of the nose may be built up to avoid excessive pressure on the bridge of the nose [10]. There is very little subcutaneous tissue on the nose so significant pressure can be applied to the nose before adequate pressure is achieved over the fleshy area of the cheeks.

The plaster pattern may be used to vacuum mold the mask. A variety of plastics have been used to make masks such as polycarbonate, co-polyester, ethyl vinyl acetate and cellulose acetate butyrate [10, 11, 12]. The edges of the mask may be trimmed and smoothed. The mouth, nostrils, and eyes may be cut out of the mask and strapping may be applied.

### SUMMARY OF THE INVENTION

Embodiments disclosed herein include methods and systems for design and manufacture of face masks, and in particular TFM for use in burn therapy. In an embodiment, a system for designing a face mask may include a non-contact scanning device. The scanning device may be used to determine facial topography information. The gathered facial topography information may be used in a CAD/CAM system to design a face mask. A face mask design may be exported to a computerized manufacturing device to manufacture a positive model of the client's face. A face mask may be molded using the model of the client's face.

Scanning devices disclosed herein generally include one or more laser light sources and one or more cameras coupled together to form a scanning head. The scanning head may be movable along one or more guides. One or more position sensors may be coupled to the scanning head. During use, data gathered by the scanning head may be correlated with position data from the position sensors to form a computerized model of a scanned face. In an embodiment of a scanning device, the scanning head may be movable by hand. An advantage of such embodiments may be that elimination of motive devices associated with the scanning head may allow the scanning device to be lighter and more easily transportable.

It is envisioned that by reducing the size and expense of the scanning device, a larger number of burn care facility may be able to design TFM for their patients. In such cases, the TFM may be designed at the facility by a clinician (e.g., a skilled artisan may not be required). Mask fabrication could be handled locally at the burn facility or by sending the data to a central fabrication facility. Central fabrication is common in prosthetics and orthotics and many central fabrication facilities can accept data electronically.

### BRIEF DESCRIPTION OF THE DRAWINGS

The above brief description as well as further objects, features and advantages of the methods and apparatus of the present invention will be more fully appreciated by reference to the following detailed description of presently preferred but nonetheless illustrative embodiments in accordance with the present invention when taken in conjunction with the accompanying drawings.

FIG. 1 depicts an embodiment of a computer system.

FIG. 2 depicts a perspective view of a commercially available scanning device.

FIG. 3 depicts an embodiment of a scanning device.

FIG. 4 depicts an embodiment of a screen shot of a face mask design software application.

FIG. 5 depicts an embodiment of a computerized manufacturing device forming a solid model.

FIG. 6 depicts a complete face mask.

FIG. 7 depicts an embodiment of a block diagram of DVLLD ISA BUS interface logic.

FIG. 8 depicts an exemplary embodiment of DVLLD analog video processing circuitry.

While the invention is susceptible to various modifications and alternative forms, specific embodiments thereof are shown by way of example in the drawings and will herein be described in detail. It should be understood, however, that the drawing and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE EMBODIMENTS

In an embodiment, many steps in the design of a TFM may be performed on a computer system using a CAD/CAM software application. The molding of the actual mask may be completed by conventional vacuum forming.

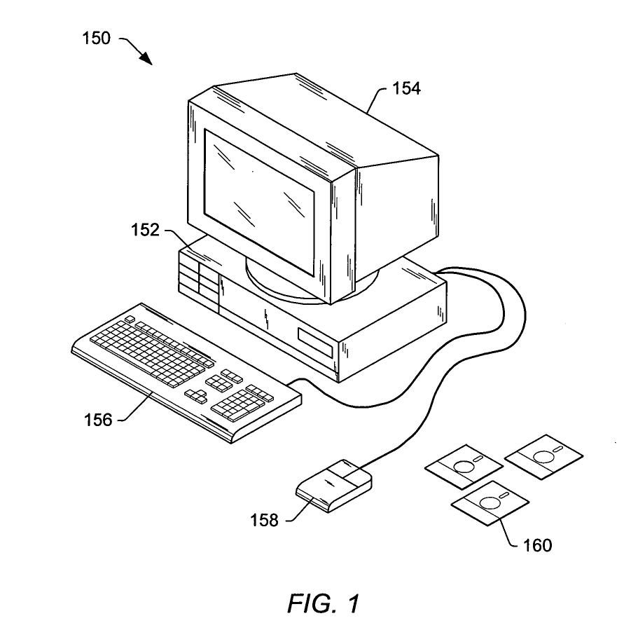

FIG. 1 illustrates an embodiment of computer system 150 that may be suitable for implementing various embodiments of a system and method for manufacturing a face mask. A computer system 150 typically includes components such as CPU 152 with an associated memory medium such as floppy disks 160. The memory medium may store program instructions for computer programs. The program instructions may be executable by CPU 152. Computer system 150 may further include a display device such as monitor 154, an alphanumeric input device such as keyboard 156, and a directional input device such as mouse 158. Computer system 150 may be operable to execute the computer programs to design a face mask and/or control a computerized manufacturing device to manufacture a solid model of a client's face.

Computer system 150 may include a memory medium on which computer programs according to various embodiments may be stored. The term “memory medium” is intended to include an installation medium (e.g., a CD-ROM or floppy disks 160, a computer system memory such as DRAM, SRAM, EDO RAM, Rambus RAM, etc.) or a non-volatile memory such as a magnetic media (e.g., a hard drive or optical storage). The memory medium may also include other types of memory or combinations thereof. In addition, the memory medium may be located in a first computer which executes the programs or may be located in a second different computer which connects to the first computer over a network. In the latter instance, the second computer may provide the program instructions to the first computer for execution. Computer system 150 may take various forms such as a personal computer system, mainframe computer system, workstation, network appliance, Internet appliance, personal digital assistant (“PDA”), television system or other device. In general, the term “computer system” may refer to any device having a processor that executes instructions from a memory medium.

The memory medium may store a software program or programs operable to design and/or manufacture a face mask. The software program(s) may be implemented in various ways, including, but not limited to, procedure-based techniques, component-based techniques, and/or object-oriented techniques, among others. For example, the software programs may be implemented using ActiveX controls, C++ objects, JavaBeans, Microsoft Foundation Classes (“MFC”), browser-based applications (e.g., Java applets), traditional programs, or other technologies or methodologies, as desired. A CPU such as host CPU 152 executing code and data from the memory medium may include a means for creating and executing the software program or programs according to the embodiments described herein.

Various embodiments may also include receiving or storing instructions and/or data implemented in accordance with embodiments described herein upon a carrier medium. Suitable carrier media may include storage media or memory media as described above. Carrier media may also include communications, such as electrical signals or electromagnetic signals (including both digital and analog signals) conveyed via a communication medium (e.g., over a computer network and/or a wireless link).

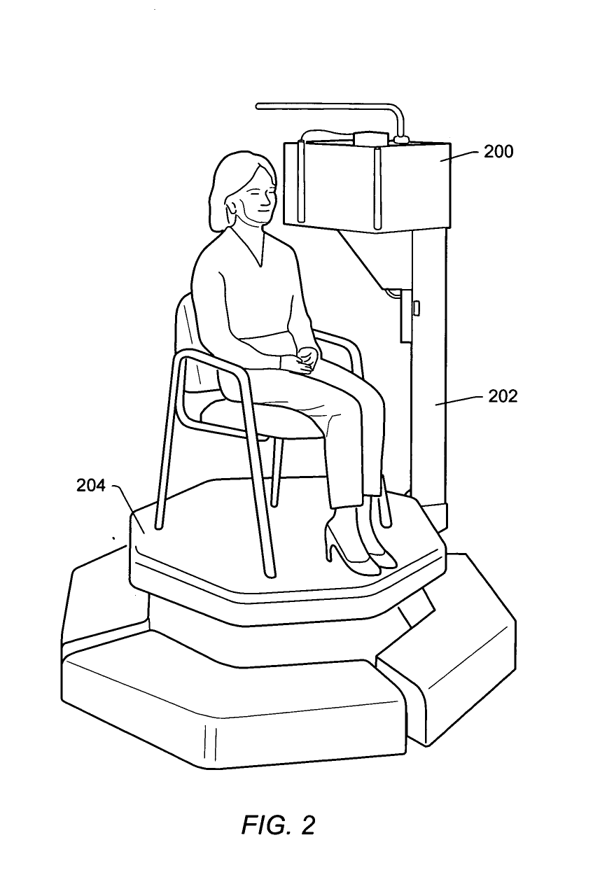

It is believed that the use of non-contact imaging for TFM fabrication was pioneered at Wright Patterson AFB in about 1995. That study demonstrated that acquiring the shape of a client's face using non-contact imaging was relatively accurate, quick and painless [9]. That work has been continued at Total Contact, Inc. of Dayton, Ohio. Since the initial pioneering work of non-contact imaging for TFM manufacture, the systems used for capturing topography information have been relatively bulky and expensive. For example, FIG. 2 depicts an embodiment of a commercially available scanning device which has been used to acquire topography information. The scanning system depicted in FIG. 2 generally includes a scanning head 200 and motive apparatus 202. During use, scanning head 200 typically projects a vertical plane of laser light toward a client positioned on platform 204. Generally, motive apparatus 202 moves the scanning head around the client in a circular motion. Often such scanning devices gather color information as well, thereby allowing a computer system coupled to the scanning system to generate a color, three-dimensional computerized model of the portion of the client's anatomy scanned by the scanning device (e.g., the client's head).

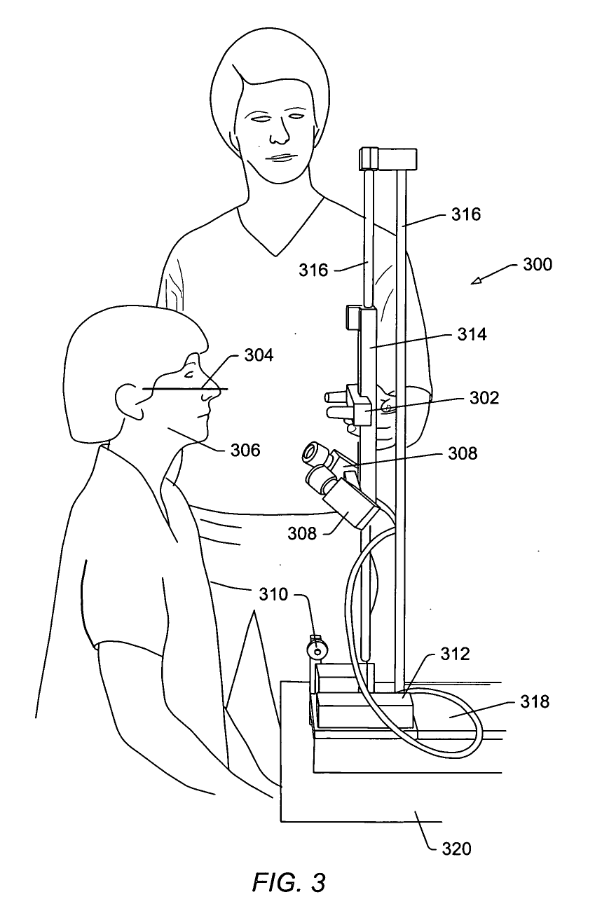

In an embodiment, a scanning device 300 as depicted in FIG. 3 may be used to acquire topography of the face 306 for face mask design. Scanning device 300 may use one or more lasers 302 to project a line 304 across a client's face 306. One or more video cameras 308 and a position sensor 310 may be used to determine the three-dimensional location of projected line 304. Hardware and software incorporated on a computer interface device 312 may pre-process data from position sensor 310 and one or more cameras 308 before sending the topography data to a computer system. For example, computer interface device 312 may extract the location of the projected line from the video signal and position information.

Laser 302 may be a low power laser that is selected to be safe to project onto a client's face. For example, the laser may pose little or no risk of damage to the client's eyes. An example of a suitable, commercially available laser may include the model SNF-501L60-670-5 laser line generator with a 60-degree fan angle. This laser line generator is available from Lasiris, Inc. of St. Laurent, Quebec, Canada. Laser 302 may project a horizontal line across the client's face. By using a horizontal line, the laser may be swept across the entire face by a simple up and/or down motion.

Suitable cameras may include, but are not limited to commercially available cameras such as the Sony XC-75 Camera ½″ CCD model camera available from Sony Corp. Cameras 308 may be coupled to or equipped with a band pass filter to distinguish ambient light from light produced by laser 302. For example, laser 302 may produce light having a wavelength of about 670 nm. In such a case, a band pass filter associated with cameras 308 may inhibit detection of light outside a wavelength range of about 667 nm to about 673 nm. For example, suitable band pass filters, which may be placed behind the lens of a camera, may include model number 670-DF10 unblocked 15.5 mm bandpass filters commercially available from Omega Optical Inc. of Brattleboro, Vt. In an embodiment, the position and/or angle of the one or more cameras 308 may be optimized for scanning faces. For example, in some scanning systems, the angle between the camera(s) used and an associated laser light source may cause portions of the face to be obscured during scanning. In particular, the area beneath the eyebrow ridge and chin may be obscured. In such cases, the topography information regarding the obscured portions of the face may not be captured. To capture as much of the facial topography as possible, two or more cameras 308 may be directed upward at an angle of approximately forty-five degrees. Such a configuration may aid in capturing the contour beneath the chin and the eyebrow ridge. Additionally, if a client's hair tends to hang over portions of the client's face, a hair retaining device may be used during the scanning process. For example, a hair clip or hair cap may be used to retain the client's hair in a position that allows the entire face to be scanned.

Cameras 308 and lasers 302 may be mounted on a scanning head 314. In an embodiment, scanning head 314 may be movable along one or more guides 316. For example, guides 316 may include two or more parallel metal rods projecting upwards from a base 318. Base 318 may rest on a table 320 or other available support to position the scanning device relative to the client. Scanning head 314 may be moved vertically with respect to a client being scanned, from below the chin to above the hairline. In certain embodiments, a scanning head could be mounted to traverse a client's face horizontally. However, such embodiments may require additional features to allow the scanning head or client to be positioned vertically with respect to one another. By orienting the scanning head to move vertically, no vertical adjustment feature is required.

Guides 316 may assist the operator in moving scanning head 314 substantially linearly. In an embodiment, scanning head 314 may be moved by an operator by hand. Thus, the scanning device may not require a motor or other motive apparatus coupled to scanning head 314. Such a configuration may allow the scanning device to be lighter weight and/or cheaper to manufacture than configurations which require motors or other motive apparatus. In an embodiment, three or more guides 316 may be used. Such embodiments may allow scanning head 314 to be substantially constrained to linear motion. Additionally, scanning head 314 may interact with guides 316 to limit non-linear motion. For example, linear bearings, high tolerance slides, etc, may be used to couple scanning head 314 to guides 316. Such bearings, slides etc. are commonly available. In certain embodiments, one or more additional position sensors may be used to detect non-linear motion (e.g., side-to-side motion of the scan head relative to the client, motion of the scan head toward or away from the client, and/or rotation of the scan head in any direction). For example, six-degree of freedom position sensors or motion sensors may be used (e.g., solid state gyroscopic motion sensors). In such embodiments, the scan head may be entirely hand-held, with no guides needed. It is believed that hand-held scan head may provide a more compact scanning device for portable use.

As scanning head 314 is moved, position sensor 310 may determine the position of scanning head 314 relative to base 318. The position of scanning head 314 relative to base 318 may be used to determine relative position of the line projected on the client's face throughout the range of motion of scanning head 314. Position data may then be correlated with topography information gathered by cameras 308 to form a computer model of the client's face. As used herein, a “position sensor” refers generally to any device capable of determining relative position and/or motion of two or more objects and/or absolute position or motion of two or more objects. For examples position sensors may include, but are not limited to: position encoders (e.g., optical or mechanical encoders, such as quadrature shaft encoders), electromagnetic sensors (e.g., resistive or inductive sensors or magnetostrictive position sensors), optical sensors, motion sensors (e.g., gyroscopic motion sensors), etc. A suitable position sensor may include the model number DPT250-1250-111-1130 Cable Extension Transducer available from Clesco Transducer Products Inc. of Canoga Park, Calif.

Computer interface device 312 may be configured to correlate data from position sensor 310 and cameras 308. Alternately, a computer system coupled to the scanning device may include hardware and/or software configured to correlate position and topography data. An advantage of including computer interface device 312 may be that a typical generic computer system may be used with the scanning device with only the addition of CAD/CAM software. That is, a nonstandard hardware configuration may not be required for the computer system. In certain embodiments, the computer system may include driver software to interface with computer interface device 312. For example, the WinRT Toolkit application compatible with the computer system's operating system may be used. The WinRT Toolkit application is commercially available from BlueWater Systems of Edmunds, Wash. Another example may include the WinDrive Toolkit commercially available from Jungo Ltd. of Netanya, Israel. Computer interface device 312 may include a dual video laser line detector (DVLLD). For example, one embodiment of a suitable computer interface device, which is a DVLLD is described below. An exemplary DVLLD is commercially available in an imaging scanner sold by Seattle Limb Systems of Poulsbo, Wash. The DVLLD boards used by Seattle Limbs Systems are manufactured by Applied Custom Technologies in San Antonio, Tex.

In an embodiment, a Dual Video Laser Line Detector (DVLLD) may include an Industry Standard Architecture (ISA) bus interface, video processing, positional sensing and general I/O functions for use with a target computer system. Generally, a DVLLD hardware design may be partitioned into five areas of functionality:

ISA Bus Interface Logic

Analog Video Processing

Laser Line Discrimination and Capture

Quadrature Shaft Encoder Processing

General Purpose I/O

These different areas of functionality are discussed further below.

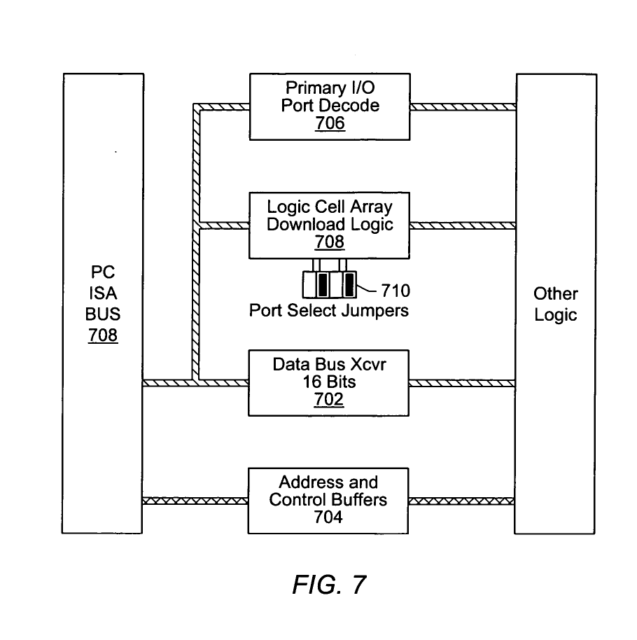

FIG. 7 depicts a block diagram of DVLLD ISA BUS interface logic. In general, DVLLD ISA BUS interface logic may include but is not limited to: data bus transceivers 702 (e.g., 16 bit data bus transceivers), address and control buffers 704, primary I/O port decode 706, and logic call array download logic 708. Additionally, jumpers 710 may be available to set various properties. For example, jumpers may be used to select an I/O port address and/or to select interrupts.

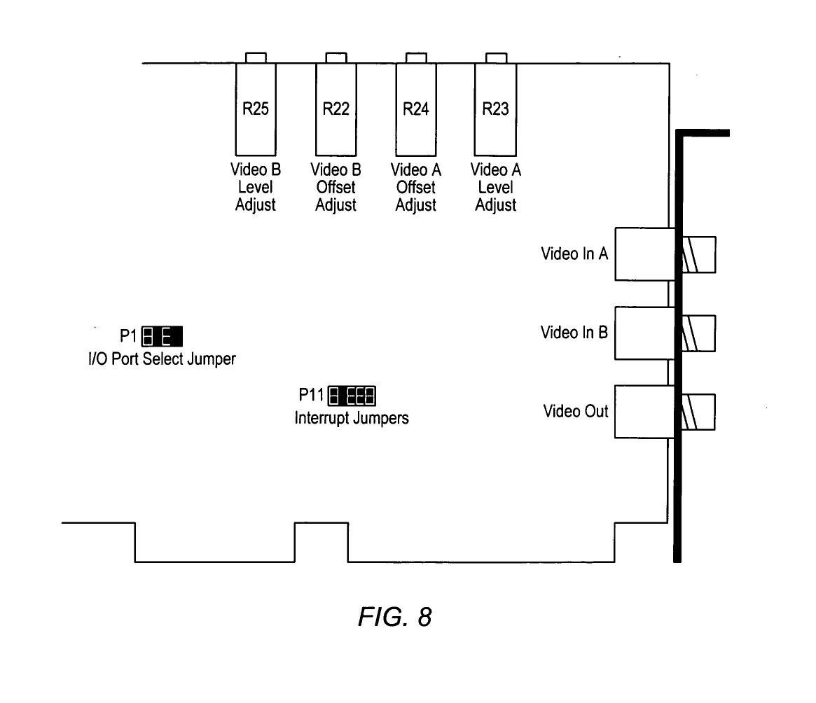

FIG. 8 depicts an exemplary embodiment of DVLLD analog video processing circuitry. The DVLLD analog video circuitry may support at least two simultaneous RS-170A compliant video input signals. Such video input signals are typically provided by modern video cameras. Additionally, the DVLLD analog video circuitry may provide at least one composite video output signal. The video output signal may be a slightly delayed and processed version of one (software selectable) of the video input signals. The DVLLD may include adjustments for video input offset, video level, laser line discrimination threshold and/or output video source selection.

In an embodiment, a DVLLD may be used to examine a video input signal in order to locate and capture the position of a laser line image which may be present in the video signal. A number of circuits may be used to accomplish this function, including but not limited to: a laser line discrimination threshold Digital to Analog Converter (DAC), a laser line discrimination comparator, a discrimination threshold video feedback circuit, a video synchronization signal extraction circuit and/or video field capture logic.

The laser line discrimination threshold DAC may include a dual eight-bit DAC, which may be used to set the threshold reference signal for each of the laser line discrimination comparators. Each DAC may feed an operational amplifier, which may convert its current output signal to a voltage suitable for input to the non-inverting terminal of each comparator. The DAC range may be approximately 1.5 volts from 0 to +1.5 volts DC.

The laser line discrimination comparator (one for each video input) may be a high-speed differential output comparator used to detect the leading edge and trailing edge of a laser line signal present in the video input signal. In an embodiment, each video input may include a laser line discrimination comparator. When the video input signal level is above the level set by the threshold DAC then the comparator's output may switch states. Once the video signal drops below the threshold, the comparator's output may switch back. The comparator's digital output signals may be used to trigger the capture of horizontal position information (e.g., from a position sensor) for storage and subsequent retrieval.

The discrimination threshold video feedback circuit may provide a visual representation of the threshold level for interactive adjustment prior to data capture. This may be accomplished by replacing the portion of the laser line signal which is above the threshold level with a black level signal. The laser line signal would normally show up in the output video signal as a bright white signal.

The circuitry in the capture logic may utilize video timing signals to perform its function. These signals may be provided by the video synchronization extraction circuit. A video synchronization extraction circuit may be based on a LM1881 Video Sync Separator chip commercially available from National Semiconductor. This chip may accept an AC coupled composite video signal and may separate the synchronization signals for individual output. The Video Sync Separator chip may provide output signals including, but not limited to: a Vertical Sync signal, a Composite (Horizontal) Sync signal, an Odd/Even field signal and/or a Burst/Back porch signal.

The DVLLD may contain circuitry for interfacing with one or more position sensors. For example, if the position sensor includes a quadrature shaft encoder, the position sensor interface circuitry may provide for direct reading of the shaft encoder position information by the host processor and for automated position capture at the beginning and end of the ‘even’ video field when video field acquisition is enabled. The position sensor interface circuitry may also perform functions such as, but not limited to digital filtering, Schmitt-triggered input buffers, quadrature decoding, latched counter, and bus interface. When the DVLLD is placed in video field capture mode the current value of the position counter may be automatically read and placed in the field buffer at beginning and end of each field captured. This allows compensation for movement during scan line capture.

A DVLLD may be designed with its logic circuitry implemented within a Field Programmable Gate Array (FPGA). For example, a Logic Cell Array commercially available from Xilinx, Inc may be used. This type of FPGA may be static RAM based and therefore may download configuration data after power has been applied. This type of device may support a variety of methods for down loading configuration data. For example, a Slave mode may be used in which the host processor performs the download operation.

Table 1 includes a list of I/O ports which may be used for operational control of the DVLLD, in one embodiment. I/O port addresses may be on a word (16 Bit) boundary even if the data associated with most of them is a byte value. Several I/O ports are discussed below:

LDCMDR—Load Command Register [Base+00h]: Write port. The contents of the System Data Bus D0-D7 may be written to the Command Register, as discussed below.

LDCUR—Load the Cursor Register [Base+02h]: Write port. The contents of the System Data Bus D0-D7 may be written to the Cursor Register. The Cursor Register value may be used to determine on which scan line the cursor should be displayed when it is enabled.

DACWRT—Load the Threshold DAC Register [Base+04h]: Write port. The contents of the System Data Bus D0-D7 may be written to the currently selected Threshold DAC Register. In an embodiment there may be at least one DAC register for each camera. The active DAC register may be selected by Bit 7 in the Command Register. The DAC output may range from 00h≅0 volts to FFh≅1.5 volts.

RAMRD—Read the next value from the capture buffer [Base+06h]: This port may read to retrieve the captured laser position values for each scan line. Each succeeding read of this port may increment the buffer address pointer to the next address. This may be a word (16 bits) port and may be accessed with word port read instructions. The most significant bit of the capture buffer address may be determined by Bit 6 of the Command Register.

CLRINT—Clear the Field Captured Interrupt [Base+08h]: An I/O port write to this port may clear the Field Captured Interrupt.

RPOS—Dynamically read the current value of the shaft encoder counter [Base+0Ah]: An I/O read to this port may latch the current value of the position sensor counter and transfer it to the System Data Bus. This port may operate in conjunction with Command Register Bit 4. For the data read from this port to be valid, the MSB of the count value may be read first, followed by the LSB.

WROP—Write the Latched Output Port [Base+0Ch]: The contents of the System Data Bus D0-D7 may be written to the eight-bit Output Port Register. This may be a general purpose buffered output port and six of the signals may be available at connector P9. A cable assembly may extend the signals at connector P9 and make them accessible at a DB-25 connector on the back of the host PC. Bits 6 and 7 of the port may be available at P10 pins 4 and 6.

SIP—Read the Strobed Input Port [Base+0Eh]: An I/O port read to this address may enable the signals present on the general purpose Four Bit Strobed Input Port to be gated onto D0-D3 of the System Data Bus. These signals may be available at connector P9. A cable assembly may extend the signals at connector P9 and make them accessible at a DB-25 connector on the back of the host PC.

SOP—Write the Strobed Output Port [Base+10h]: An I/O port write to this address may enable Bits D0-D3 of the System Data Bus to be buffered and driven onto assigned pins of connector P9. A cable assembly may extend the signals at connector P9 and make them accessible at a DB-25 connector on the back of the host PC.

TABLE 1

| | A | A | A | A | A | IO | IO | CMD | |
|---|---|---|---|---|---|---|---|---|---|
| HEX | 4 | 3 | 2 | 1 | 0 | W | R | NAME | OPERATION |
| 00 | 0 | 0 | 0 | 0 | 0 | 4 | — | -LDCMDR | Load Command |
| | | | | | | | | | Register |
| 02 | 0 | 0 | 0 | 1 | 0 | 4 | — | -LDCUR | Load Cursor |
| | | | | | | | | | Register |
| 04 | 0 | 0 | 1 | 0 | 0 | 4 | — | -DACWRT | Load DAC |
| | | | | | | | | | Register |
| 06 | 0 | 0 | 1 | 1 | 0 | — | 4 | -RAMRD | Read Capture |
| | | | | | | | | | Buffer |
| 08 | 0 | 1 | 0 | 0 | 0 | 4 | 4 | -CLRINT | Clear Interrupt |
| 0A | 0 | 1 | 0 | 1 | 0 | — | 4 | -RPOS | Read Shaft En- |
| | | | | | | | | | coder Position |
| 0C | 0 | 1 | 1 | 0 | 0 | 4 | — | -WROP | Write Latched |
| | | | | | | | | | Output Port |
| 0E | 0 | 1 | 1 | 1 | 0 | — | 4 | -SIP | Read Strobed |
| | | | | | | | | | Input Port |
| 10 | 1 | 0 | 0 | 0 | 0 | 4 | — | -SOP | Write Strobed |
| | | | | | | | | | Output Port |

A general description of a typical procedure for acquiring surface profiles under interrupt control is described below:

A. Configure the DVLLD adapter for installation onto the target computer system. This may entail setting the Base I/O port address and interrupt line.

B. Once a video source has been selected for use with the DVLLD, the input video level and offset may need to be adjusted for that source. In some embodiments two or more video sources (e.g., cameras) may be used with the DVLLD.

C. Using an appropriate Base port and offset the LCA may be configured. If the LCA configuration was successful then proceed to the next step. If not there may be a conflict with the Base I/O port selected. Verify that no other adapter in the target system is using the selected I/O port.

D. The acquisition software on the target computer system should provide an Interrupt Service Routine which will respond to the interrupts generated by the DVLLD hardware. This ISR may be responsible for extracting the captured profile data from the capture buffers and preparing the system for the next DVLLD generated interrupt. The following is a sequence of steps which may be implemented in the ISR:

1. Install interrupt vector to ISR and enable the appropriate PIC chip to sense the interrupt.

2. Clear command register and reset buffer pointer (e.g., by writing a 00h then a 10h then a 00h to the command register port).

3. Select a camera, enable captures and enable interrupts (e.g., by writing a 23h to the command register port).

4. Clear any invalid interrupts (e.g., by writing any byte value to the Clear Interrupt port).

5. The ISR may initially disable captures and interrupts and reset the buffer pointer (e.g., by writing 30h then 20h to the command register port).

6. The ISR may then read the entire hardware buffer into a main memory buffer (e.g., by executing word port reads to the Read Capture Buffer port).

7. The current interrupt may be cleared (e.g., by writing any byte value to the Clear Interrupt port).

8. Before exiting the ISR the buffer pointer may be reset, a camera selected and acquisition and interrupts enabled (e.g., by writing a 10h then 23h to the command register port). This may be followed by issuing a non-specific End Of Interrupt command to the PIC chips.

In general, facial topography information may be gathered by scanning using a system as described above in less than about five seconds. For the client the scanning process may be painless and non-anxiety provoking. Additionally, such rapid non-contact data acquisition may reduce the amount of time the client must remain relatively motionless in order to gather accurate facial topography information. In an embodiment, the quantity of data sent to a computer system coupled to the scanning device may be reduced by substantially limiting the data to facial topography data. That is, color information may be omitted. Additionally, the transferred data may not include information to construct a three-dimensional model of the client's entire head. Rather the data may include data to form a surface model of the client's face.

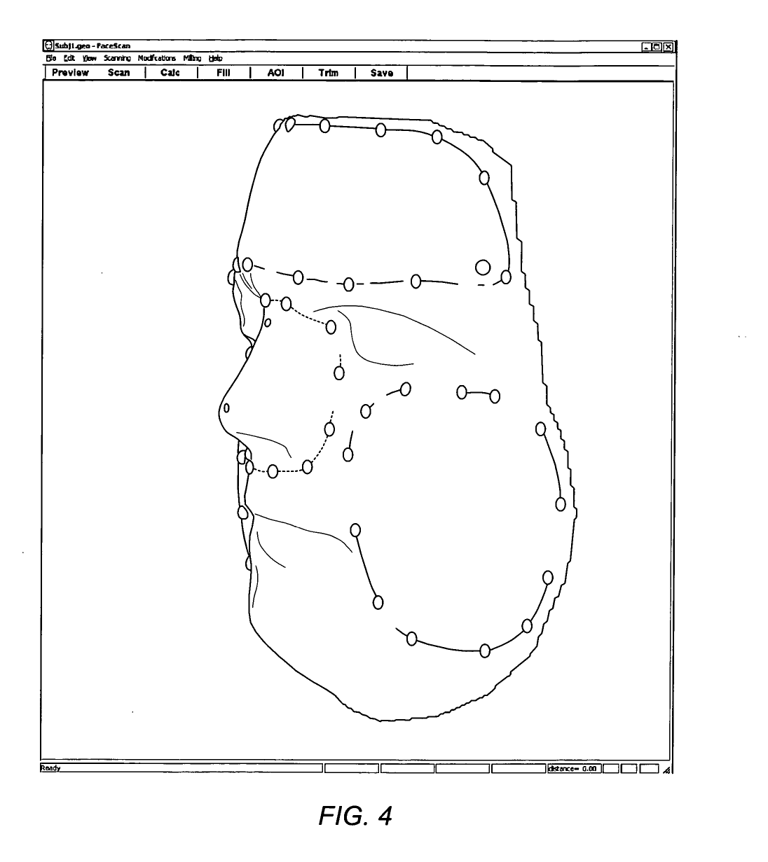

In an embodiment, the scanning device may communicate with a computer system. The computer system may include a software application configured for face mask design and fabrication. For example, suitable software applications may include the FaceScan software application, produced by the University of Texas. FIG. 4 depicts an exemplary embodiment of a screen shot from the FaceScan software application. FaceScan integrates image acquisition, face mask design and computerized manufacturing device interface into a single software application. In an embodiment, image acquisition may take place in real-time such that, when scanning is complete, the scan information is immediately available on the computer system to begin computer-aided mask design.

A software application for designing a face mask may use facial topography data to form a computerized model of a client's face. The software application may allow a user to interact with the computerized model to make local and/or global modifications. Examples of local and/or global modifications may include, but are not limited to trimming certain data from the scan (e.g., where the computerized model includes data that will not be used in forming the final mask). Additionally, voids in the computerized model data may be filled (e.g., by interpolation). The computerized model may also be smoothed. Smoothing may be global (e.g., over the entire face model) and/or local (e.g., around specific features, such as scars). Local regions are interactively defined by selecting an area of interest about the local region (e.g., using a pointer, computer mouse or similar device). Selected portions of a computerized model may also be reshaped. For example, portions of the computerized model may be reshaped to reduce the pressure of the face mask against the client's face at various points. For example, in an embodiment, a portion of the computerized model may be selected. A control line may be selected within the selected portion. The computerized model may be modified by moving the control line with respect to the remainder of the computerized model. The software application may then smooth the selected portion over the new location of the control line. In an embodiment, modifications (including reshaping, smoothing, trimming, etc.) of the computerized model may be changed and/or deleted.

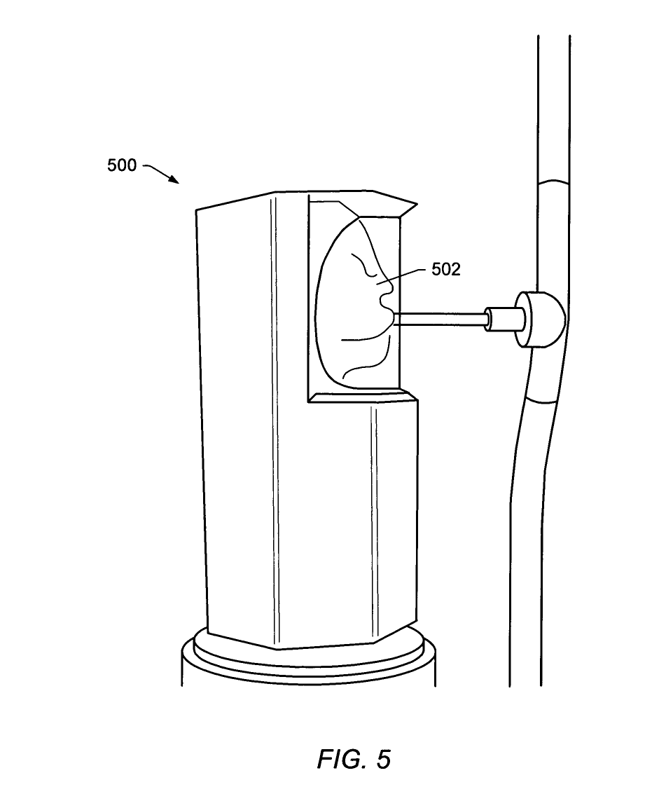

When the computerized model is complete, the software application may send control information to a computerized manufacturing device to form a solid model of the client's face. A computerized manufacturing device may be configured to form a solid model substantially corresponding to the computer model. As used herein, “computerized manufacturing” may refer to computer-controlled formation of a solid model. Examples of computerized manufacturing systems and devices may include, but are not limited to: computer numerical controlled (CNC) milling systems, stereo lithography systems, laser sintering systems, etc. Computerized manufacturing systems are commercially available from a variety of manufacturers. FIG. 5 depicts an exemplary embodiment of a computerized manufacturing device 500 forming a solid model 502 of a client's face. In certain embodiments, the solid model formed by the computerized manufacturing device may be further processed to prepare it for casting a face mask. For example, the solid model may be sanded to smooth its surface, etc.

In certain embodiments, the position of the solid model of the client's face in the blank may be interactively modified via the mask design software application. The software application may also perform interference checking to compensate for the size of the cutting tool. Additionally, the milling tool path can be previewed in the software application. The computerized model data may be sent directly (e.g., via a serial connection) to the computerized manufacturing device. The mask design software application may export the computerized model in an industry standard data format (e.g., IGES format, AAOP compatible formats, etc.) or a data format specific to the computerized manufacturing device being used.

In one example, the computerized manufacturing device may include a three axis milling machine. Data sent to the milling machine may include appropriate coordinates (e.g., radial coordinates) with appropriate resolution (e.g., an angular resolution of about 0.5 degrees and 1 mm z resolution). Cartesian coordinates may also be used for example. The milling machine may interpolate additional points for greater smoothness. For example, the milling machine may interpolate four points between each z increment. At such a resolution, no additional smoothing of the pattern may be required. In an embodiment, the milling machine may use a ¼^{th} inch ball endmill for cutting a foam blank to from the solid model. Some such devices have about a two inch length of cut, which may allow milling the solid model in a single pass. The resulting solid model may be formed from a urethane foam blank. The milling process typically takes between about 5 and 8 hours. The milling process may take less than 2 hours. The speed of the milling process is dependent upon the equipment used.

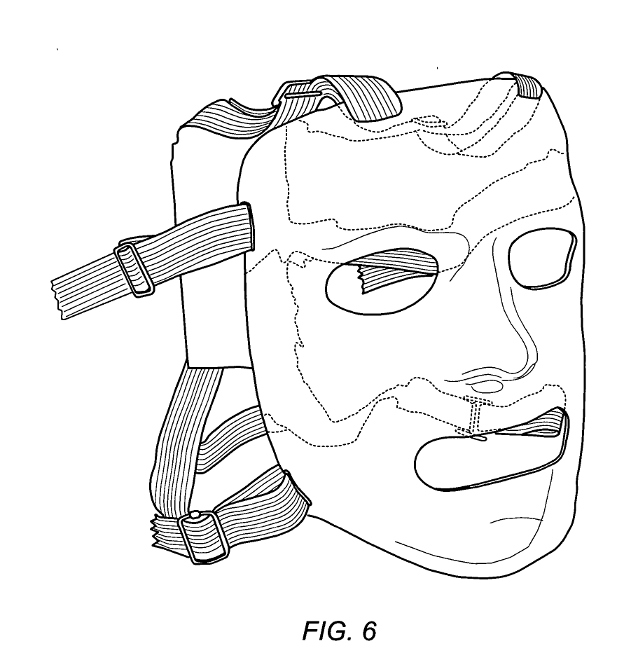

In an embodiment, after the solid model is formed, an intermediate layer may be applied to the solid model before the face mask is formed. For example, a relatively thin sheet of plastic (e.g., 1/16^{th} inch polypropylene) may be vacuum formed over the model. The intermediate layer may reduce the tendency of the mask material to stick to the solid model. Thus, the intermediate layer may act as a mold release of the final mask. In addition, in certain embodiments, another mold release agent may be used. For example, a silicone mold release agent may be applied to the outside of the intermediate layer. The intermediate layer may also provide a smoother surface than the solid model upon which to form the face mask. The face mask may then be molded over the intermediate layer. In an embodiment, the face mask may be formed using co-polyester, or another suitable material, as previously described. After molding, the face mask may be removed from the solid model and trimmed. Holes may be cut in the face mask for the client's eyes, nostrils and mouth. Edges of the mask may be rounded over to minimize sharp edges. A retaining device may be coupled to the face mask. For example, a six point elastic harness may be attached to the mask that makes for easy adjustment of mask pressure. FIG. 6 depicts an embodiment of a completed face mask.

In this patent, certain materials (e.g., articles) have been incorporated by reference. The text of such materials is, however, only incorporated by reference to the extent that no conflict exists between such text and the other statements and drawings set forth herein. In the event of such conflict, then any such conflicting text in such incorporated by reference materials is specifically not incorporated by reference in this patent.

While the present invention has been described with reference to particular embodiments, it will be understood that the embodiments are illustrated and that the invention scope is not so limited. Any variations, modifications, additions and improvements to the embodiments described are possible. For example, methods and/or systems described herein may be used to design and/or manufacture face masks for other applications (e.g., sports). These variations, modifications, additions and improvements may fall within the scope of the invention as detailed within the following claims.

The following publications are incorporated by reference as though fully set forth herein:

1. Richard R, Staley M, editors. Burn Care and Rehabilitation: Principles and Practice. Philadelphia: F A Davis; 1993, 409-415.

2. Morgan R F, Nichter L S, Haines P C, Kenney J G, Friedman H I, Edlich R F, Management of head and neck burns. Journal of Burn Care & Rehabilitation. 6(1):20-38, January-February 1985.

3. Ward S R, Pressure Therapy for the Control of Hypertrophic Scar Formation after Burn Injury, J Burn Care Rehabil 1991; 12:257-62.

4. Gallager J, Goldfarb I W, Slater S, Rogosky-Grassi M, Survey of Treatment Modalities for the Prevention of Hypertrophic Facial Scars, J Burn Care Rehabil 1990; 11:118-20.

5. Ketchum L D, Cohen I K, Masters F W. Hypertropic scars and Keloids. A collective review. 1974, Plastic and Reconstructive Surgery, 53 (2), 140-54.

6. Rivers E A, Strate R G, Solem L D. The transparent face mask. American Journal of Occupational Therapy. 1979, 23 (2), p 108-13.

7. Groce A, Myers-Paal R, Herndon D N, McCauley R L. Are your thoughts of facial pressure transparent?. J Burn Care Rehabil; 1999, 20, 478-81.

8. Parry I S, Doyle B, Hurlin-Foley K Palmieri T L, Greenhalgh D G, Does the First Impression Count?: A Survey of Current Practices and Satisfaction with the Use of Transparent Face Masks in the Treatment of Facial Scarring, Proceedings of the American Burn Association Annual Meeting, Apr. 24-27, 2002, s74.

9. Whitestone J J, Richard R L, Slemker T C, Ause-Ellias K L, Miller S F. Fabrication of total-contact burn masks by use of human body topography and computer-aided design and manufacturing. J Burn Care Rehabil; 1995. 16, p543-7.

10. Locke S. Smith S, Szeliski-Scott B, Lemaire E D. A Clear Polycarbonate Face Mask for the Treatment of Hypertrophic Scars, Journal of Prosthetics & Orthotics, 1991, Vol 3, Num 4, p182-90.

11. Shons A R, Rivers E A, Solem L D. A rigid transparent face mask for control of scar hypertrophy. Annals of Plastic Surgery. 1981; 6: 245-8.

12. Fisher F V, Help P A, editors. Comprehensive Rehabilitation of Burns. Williams & Wilkinsl 1984. p. 177-217.

13. Walsh N. E., Lancaster J. L., Faulkner V. W., Rogers W. E. A Computerized System to Manufacture Prostheses for Amputees in Developing Countries. Journal of Prosthetics and Orthotics 1989.Vol. 1 Number 3. 165-181.

14. Rogers B, Stephens S, Gitter A, Bosker G, Crawford R. Double-Wall, Transtibial Prosthetic Socket Fabricated Using Selective Laser Sintering: A Case Study. Journal of Prosthetics and Orthotics, 2000, Vol 12 Number 3, 97-103.

15. Computerized Manufacturing of Transparent Face Masks for the Treatment of Facial Scarring” Bill Rogers, Ted Chapman, Jesse Rettele, Jimmy Gatica, Tom Darm, Majorie Beebe, Donald Dilworth, Nicolas Walsh, Journal of Burn Care and Rehabilitiation, 2003;24: 91-96.

1. A scanning device comprising:
at least one laser;
at least one camera, wherein at least one laser and at least one camera are coupled to a scanning head; and
at least one position sensor, coupled to the scanning head.

2. The scanning device of claim 1, further comprising at least one guide, wherein at least one scanning head is coupled to at least one guide, and wherein at least one guide restricts movement of the scanning head to a substantially linear motion.

3. The scanning device of claim 1, further comprising a computer interface device, wherein the computer interface device is configured to correlate position information from at least one position sensor with topography information from at least one camera.

4. The scanning device of claim 1, wherein the device does not include a motive device configured to move the scanning head during use.

5. The scanning device of claim 1, wherein the scanning head is manually positionable.

6. The scanning device of claim 1, wherein the device is configurable to be transported in substantially one piece without the use of special transportation equipment.

7. The scanning device of claim 1, wherein at least one of the lasers is configurable to be safely use in a facial area of a human.

8. The scanning device of claim 1, wherein at least one camera is positioned at about a 45 degree angle upward from horizontal.

9. The scanning device of claim 1, wherein the scanning device is configured to capture facial topography information in less than about 5 seconds.

10. A scanning device comprising:
at least one laser;
at least one camera, wherein at least one laser and at least one camera are coupled to a scanning head, wherein the scanning head is manually positionable; and
at least one position sensor, coupled to the scanning head.

11. The scanning device of claim 10, further comprising at least one guide, wherein at least one scanning head is coupled to at least one guide, and wherein at least one guide restricts movement of the scanning head to a substantially linear motion.

12. The scanning device of claim 10, further comprising a computer interface device, wherein the computer interface device is configured to correlate position information from at least one position sensor with topography information from at least one camera.

13. The scanning device of claim 10, wherein the device does not include a motive device configured to move the scanning head during use.

14. The scanning device of claim 10, wherein the device is configurable to be transported in substantially one piece without the use of special transportation equipment.

15. The scanning device of claim 10, wherein at least one of the lasers is configurable to be safely use in a facial area of a human.

16. The scanning device of claim 10, wherein at least one camera is positioned at about a 45 degree angle upward from horizontal.

17. The scanning device of claim 10, wherein the scanning device is configured to capture facial topography information in less than about 5 seconds.

18. A method, comprising
determining topography information regarding a client's face by moving a scanning head of a non-contact scanning device relative to the client;
determining position information of the scanning head as the scanning head is moving; and
determining a computerized model of the client's face by correlating the determined position information and the determined topography information.

19. The method of claim 18, further comprising modifying the computerized model of the client's face.

20. The method of claim 18, further comprising modifying the computerized model of the client's face with user input.

21. The method of claim 18, further comprising modifying the computerized model of the client's face with computer assisted interpolation.

22. The method of claim 18, further comprising sending the computerized model of the client's face to a computerized manufacturing device to form a solid model.

23. A method, comprising
determining topography information regarding a client's face by moving a scanning head of a non-contact scanning device relative to the client;
substantially simultaneously determining position information of the scanning head and capturing topography information while moving the scanning head; and
determining a computerized model of the client's face by correlating the determined position information and the determined topography information.

24. The method of claim 23, further comprising modifying the computerized model of the client's face.

25. The method of claim 23, further comprising modifying the computerized model of the client's face with user input.

26. The method of claim 23, further comprising modifying the computerized model of the client's face with computer assisted interpolation.

27. The method of claim 23, further comprising sending the computerized model of the client's face to a computerized manufacturing device to form a solid model.

28. A method, comprising:
providing a solid model of a face;
applying an intermediate layer to the solid model;
applying a mask forming material over the intermediate layer to form a face mask; and
separating the face mask from the solid model.

29-43. (Cancelled)
